(19) United States
(12) Patent Application Publication
(10) Pub. No.: US 2007/0205052 A1
(43) Pub. Date: Sep. 6, 2007

(54) Ladder attachment device

(76) Inventor: John Dawson, Otahuhu (NZ)

Correspondence Address: YOUNG & THOMPSON, 745 SOUTH 23RD STREET, 2ND FLOOR, ARLINGTON, VA, 22202, US

(21) Appl. No.: 11/708,588

(22) Filed: Feb. 21, 2007

(30) Foreign Application Priority Data
Feb. 22, 2006 (NZ) 545474

(51) Int. Cl. E06C 5/32

(52) U.S. Cl. 182/129

(57) ABSTRACT

A ladder attachment device having at least a substantially rigid and substantially planar first member which is connectable at or adjacent a first end to a substantially flat portion of a rung or a top member of a ladder. A substantially rigid and elongate second member pivotally is connected at or adjacent a second end of the first member. The device can be clamped to the rung or top member of a ladder to provide a storage area for tools or materials, and the elongate member provides additional support for the ladder. The first member sets the ladder back from a wall or structure meaning that a person working on the ladder tends to lean into the ladder when working, rather than leaning back which can cause a ladder to topple.

### FIELD OF THE INVENTION

This invention relates to a ladder attachment device, and particularly, but not exclusively, to a ladder attachment device to aid the stability of a ladder and/or to provide a storage location for equipment or materials on a ladder.

### BACKGROUND

Ladders are often unstable and many accidents arise from the use of ladders. Instability is sometimes caused by sloping or uneven ground upon which the ladder is supported, but is often also caused by poor contact or stability between the top of the ladder and the structure upon which it leans.

Another cause for instability is a misjudged centre of gravity. When a ladder is set steeply, and a person who is supported by the ladder moves his body away from the ladder to perform a job, the centre of gravity of the ladder and the person on it can move behind the ground engagement point, and the ladder can fall backwards.

Similarly, if a person on a ladder reaches too far out to the side of the ladder the ladder can slide or twist and fall. The tops of ladders are often narrow and if the structure on which the ladder is leaning is a little uneven, or is not strong enough, this problem can be aggravated.

A further difficulty experienced by ladder users is that there is often nowhere to store or support tools, equipment or materials when working up a ladder. With no place to store materials, for example a tin of paint, one hand may be used to hold the materials while the other is used to carry out a job. This can lead to a loss of stability and an accident.

While a number of ladder attachment devices have been proposed or used in the past, they tend to be slightly cumbersome to use or store and tend to rely on a connection with a number of rungs on a ladder and for this reason are not versatile enough to be used with a wide range of ladders from different manufacturers.

### OBJECT

It is therefore an object of the present invention to provide a ladder attachment device that will go at least some way toward overcoming the above problems, or which will at least provide the public with a useful choice.

### STATEMENTS OF THE INVENTION

Accordingly, in a first aspect, the invention may broadly be said to consist in a ladder attachment device, having at least a substantially rigid and substantially planar first member which is connectable at or adjacent a first end to a substantially flat portion of a rung or a top member of a ladder, and a substantially rigid and elongate second member pivotally connected at or adjacent a second end of the first member.

Preferably the first member is adapted such that it can be clamped to the substantially flat portion of a rung or top member of a ladder.

Preferably the first member is connectable to the substantially flat portion of a rung or top member of a ladder using at least one bolt.

Preferably the first member includes at least one lug which is adapted to abut a side of the rung or top member of a ladder to which the attachment device is connected.

More preferably, the first member includes at least two lugs which are adapted to abut a side of the rung or top member of a ladder, one of each of the said lugs being situated each side of a first centreline of the first member, the first centreline being that which extends from the first end of the first member to the second end.

Preferably the distance between the first end and the second end of the first member is within the range of between about two hundred millimetres and six hundred millimetres.

Preferably the length of the second member is greater than the width of a ladder to which the device is to be secured.

Preferably the length of the second member is greater than four hundred millimetres.

Preferably the width of the first member perpendicular to the first centreline of the device is similar to or greater than the width of a ladder to which the device is to be fitted.

Preferably the width of the first member perpendicular to the first centreline of the device is within the range of two hundred and four hundred millimetres.

Preferably the second member is provided with a friction enhancing material on at least part of its surface.

Optionally the first member is provided with a friction enhancing material on at least part of its surface.

Preferably the second member is pivotally connectable to the first member about a pivot axis that is substantially perpendicular to the first centreline of the first member.

Optionally the second member is pivotally connectable to the first member about a pivot axis that is substantially parallel to the length of a ladder to which the device is to be fitted.

As a further option the second member is pivotally connectable about two axes to the first member, the first pivot axis being substantially perpendicular to the first centreline of the first member, and the second pivot axis being substantially parallel to the length of a ladder to which the device is to be fitted.

Optionally the device includes a means to fix the second member at a particular inclination relative to the first member.

In a second aspect, the invention may broadly be said to consist in a ladder attachment device, having at least one moveable planar member and a two piece guide assembly within which the planar member can slide, the guide assembly comprising a first guide section and a second guide section which are pivotally attached to one another, and wherein the assembly forms one structurally rigid assembly when the planar member is engaged within both of the two guide sections.

Preferably the first guide section is rigidly connectable to a rung or a top member of a ladder.

Preferably the two piece guide assembly is manufactured from a substantially rigid planar material, formed into a pair of guide sleeves, such that each sleeve is able to engage with at least part of both the top and bottom surfaces of the planar member and two edges of the planar member.

Optionally the guide assembly is provided with low friction runners or bearings to allow free movement of the planar member within the guide assembly.

Preferably the guide assembly has means to stop the first rigid member sliding all the way out of the guide assembly.

Optionally the assembly of the guide assembly and the planar member is further provided with means to lock or retain the planar member at any point of its travel within the guide assembly.

In a third aspect the invention may broadly be said to consist in a ladder assembly having at least one ladder attachment device substantially as herein described.

The invention may also broadly be said to consist in the parts, elements and features referred to or indicated in the specification of the application, individually or collectively, and any or all combinations of any two or more of the parts, elements or features, and where specific integers are mentioned herein which have known equivalents, such equivalents are incorporated herein as if they were individually set forth.

### DESCRIPTION

Further aspects of the present invention will become apparent from the following description which is given by way of example only and with reference to the accompanying drawings in which:

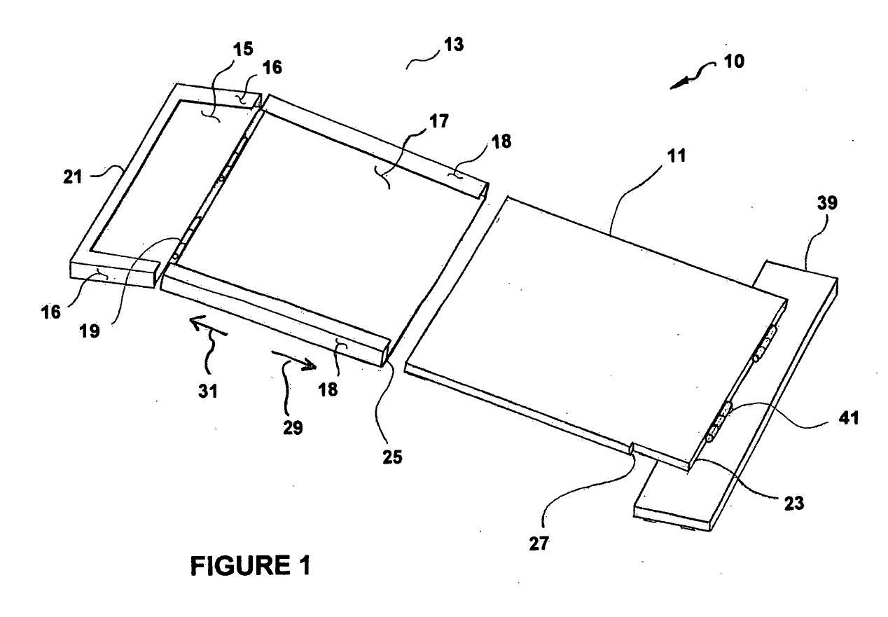

FIG. 1 is a perspective view of a first example of a ladder attachment device,

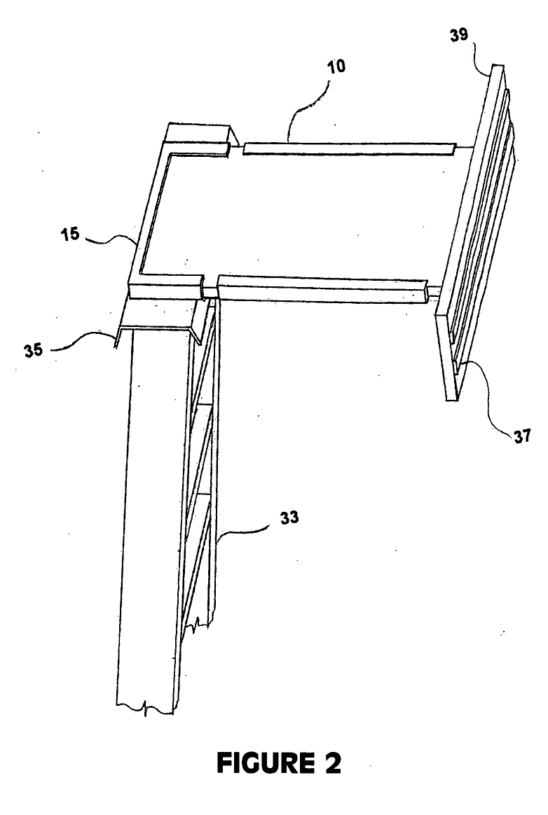

FIG. 2 is a perspective view showing the first example of the ladder attachment device fitted to the top of a ladder,

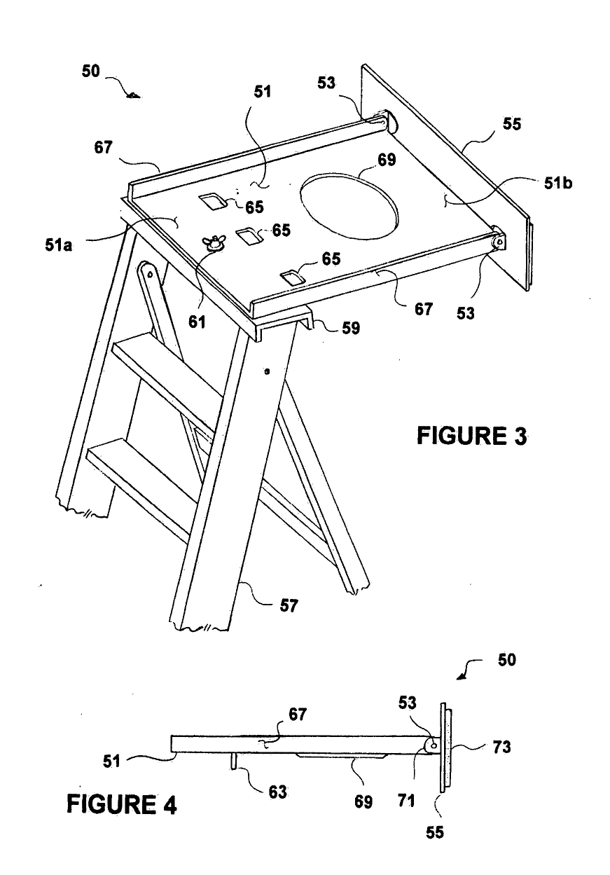

FIG. 3 is a perspective view of a second example of a ladder attachment device, and

FIG. 4 is a side elevation view of the second example of a ladder attachment device.

### FIRST EXAMPLE

With reference to FIG. 1, a first example of a ladder attachment device (10) is shown comprising a substantially rigid and substantially planar member (11) and a sleeve assembly (13). The sleeve assembly (13) comprises at least a first guide (15) and a second guide (17) and a first hinge (19) pivotally connects the two guides.

Both guides (15) and (17) have a “C” shaped profile and have an internal width that is close to the width of the planar member (11). The guides (15) and (17) can for example be made from a sheet metal material that is formed into a “C” shape having upturned edges (16) and (18) respectively. The planar member (11) is able to slide within the guides (15) and (17), the edges on each side of the planar member (11) being constrained by the upturned edges (16) and (18) of the guides (15) and (17). The first guide (15) also has a third edge or turn up (21) which acts both as a stop for the planar member (11) and also as a further retention feature to restrain the planar member (11) within the first guide when the planar member (11) is carrying a load.

In this example the ladder attachment device (10) is assembled by first introducing an edge (23) of the planar member (11) into the “C” shaped profile of the second guide (17) in the direction shown by the first arrow (29). An inwardly protruding stop (25) on the upturned edge (18) of the second guide (17) engages with a shoulder (27) on the planar member (11), to limit travel of the planar member (11) and to prevent it from falling out of the sleeve assembly (13).

A substantially rigid and elongate member (39) is shown connected to the planar member (11) by a second hinge (41).

In use the second guide (17) is raised until it is aligned with first guide (15), and then the planar member (11) is slid in the direction shown by the second arrow (31), until it reaches the stop (21). When the planar member (11) is engaged in both the first and the second guide (15) and (17) a stable and rigid platform is produced.

Movement of the member (11) in the direction shown by the first arrow (29) until the shoulder (27) meets the stop (25), allows the second guide (17) to pivot and fold away for easier transportation and storage when the ladder attachment device (10) is fitted to ladder.

With reference to FIG. 2, the ladder attachment device (10) is shown fitted to a ladder (33). In this case the first guide (15) is attached by screws (not shown) to a top rung or platform (35) of the ladder (33). The elongate member (11) is shown with strips of friction enhancing material (37), for example a foamed rubber material, which is used to improve stability when the elongate member (11) is placed against a wall or other structure.

It can be seen that the length of the elongate member (11), in the direction of the width of the ladder, is greater than the width of the ladder. This can help to improve the stability of the ladder when it is leaning against a wall.

In addition, the length of the planar member (11) will cause the ladder to stand a short distance from a wall that it is leaning against. This can be advantageous in that a person on the ladder will be more inclined to lean in towards the wall to carry out his work, rather than leaning back, meaning that he is less likely to make the ladder fall backwards.

The planar member (11) also provides a suitable shelf on which equipment or materials can be stored while working on a ladder, for example a tin of paint can be put on the planar member (11).

### SECOND EXAMPLE

With reference to FIGS. 3 and 4 a second example of a ladder attachment device (50) is shown comprising a substantially rigid and substantially planar first member (51) which is adapted to connect at or adjacent a first end (51a) to a substantially flat or planar portion of a rung or a top member of a ladder, and which is pivotally connected at or adjacent a second end (51b) to a substantially rigid and elongate second member (55). In this example, the pivotal connection between the first member (51) and the second member (55) is made with a pair of hinge pins (53).

The first member (51) is adapted such that it can be clamped to a flat portion of a rung or a top member of a ladder (56). While this could be done in a number of ways, for example by an arrangement of clamps, snap fittings, or using a number of screws or bolts, in this example the first member (51) is adapted to connect to a top plate (59) of the ladder (56) using a single bolt (61) and a series of three locating lugs or tabs (63). The three locating tabs (63) are arranged and adapted to abut or mate against an edge of a flat rung or a top step or member of a ladder, and in combination with the single bolt (61) and nut are sufficient to securely connect the first member (51) to the ladder.

In this example the three locating tabs (63) are produced in the first member (51) by simply cutting and bending three tabs from the sheet material that is used to make the first member (51). This explains the three, holes (65) that can be seen in the first member (51) in FIG. 3.

While it is envisaged that a strategically placed and sized single lug or tab (63) could be sufficient, however, preferably the first member is provided with at least two lugs or tabs (63), one of each of the tabs (63) being situated each side of a first centreline of the first member (51), the first centreline being that which extends from the first end (51a) of the first member (51) to the second end (51b).

The first member (51) is also shown having turned up sides (67). These can be formed by bending the edges of the first member (51) through about ninety degrees. The turned up edges or sides (67) give additional strength to the first member (51) and can be useful in preventing objects falling off the first member (51) when in use. In this example the first member (51) is shown having a circular shaped recessed portion (69). This circular shaped recessed portion (69) can be produced by pressing a recess into the first member (51) and can be useful to retain a tin of paint. The pressing can also improve the rigidity and appearance of the first member (51).

The first member (51) can have friction enhancing material on its upper surface to prevent articles slipping off it. The width of the first member (51), that is, the measurement perpendicular to the first centreline is ideally similar to or greater than the width of a ladder to which the device (50) is to be fitted. Preferably the width is within the range of two hundred and four hundred millimetres. This provides the first member (51) with a useful storage area on which tools and materials can be kept while working up a ladder.

The second member (55) is shown connected by two hinge pins (53) to the turned up sides (67) of the first member (51). The two hinge pins (53) pass through two tabs (71) on the second member (55). The two tabs (71) can be formed in a similar way to the locating tabs (63) on the first member (51).

Preferably at least a part of the side of the second member (55) opposite the tabs (71) is provided with a material that will enhance the friction between the second member (55) and any structure that it lies against. In this example the second member (55) is shown having a strip of foamed rubber (73) glued to one side.

The pivotal connection between the first member (51) and the second member (55) is about an axis that is substantially perpendicular to the first centreline of the first member (51).

The pivotal attachment of the second member (55) to the first member (51) allows the second member (55) to lie flat against a wall or other structure, and this can improve the connection between the second member (55) and the wall or structure, particularly when the surface of the second member (55) has a friction enhancing material on it.

Preferably the length of the second member (55) is greater than the width of a ladder to which the device (50) is to be secured, or more than about four hundred millimetres long, and more preferably the length is with the range of six hundred to one thousand millimetres long. Such a length is able to span a narrow window or window pane.

It is envisaged that the first member (51) and the second member (55) can be produced from sheet aluminium material, however other materials could be used, for example galvanised or painted sheet steel or plastics materials.

In use the ladder attachment device (50) provides a platform on which equipment or materials can be stored and at the same time it can help to enhance the stability of the ladder when in use. Since the second member (55) is longer than the width of the ladder, the top end of the ladder can be less likely to twist and fall from the surface of a structure. The friction enhancing material can also help to prevent the top of the ladder slipping, which is a typical occurrence when a person over reaches when working high on a ladder.

In addition, the length of the second member (55) can span openings or narrow window panes making it easier in some situations to find a secure location to lean a ladder against.

And the length of the first member (51), that is the length from its first end (51a) to its second end (51b), can also be an advantage. This length means that the ladder to which it is attached can be set back a small distance from a wall or structure and a person on the ladder will be more inclined to lean in towards the ladder when working on it, reducing the chance that the ladder will fall back. It is envisaged that a suitable length for the second member (55), from its first end (5la) to its second end (51b), would be between about two hundred to six hundred millimetres.

### Variations

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

A number of variations are possible, for example, in the first example the sleeve assembly (13) could be replaced with a simple framework structure to produce the two guides. Or the planar member (11) could be pivotally connectable to a ladder with a stay or stays provided to hold the planar member (11) in an extended position.

It is envisaged that the elongate member (39) or the second member (55) in the above examples could be pivotally connected to its respective planar member (11) or (51) by a number of methods, including a pivotal connection about an axis that is substantially aligned with the longitudinal axis of a ladder to which the device is to be attached.

Optionally the elongate member (39) or the second member (55) in the above examples can be pivotally connected about two axes.

Optionally each device (10) and (50) includes a means to fix the elongate member (39) or the second member (55) at a particular inclination relative to the planar member (11) or the first member (51).

### Definitions

Throughout this specification the word “comprise” and variations of that word, such as “comprises” and “comprising”, are not intended to exclude other additives, components, integers or steps.

### Advantages

Thus it can be seen that at least the preferred form of the invention provides a ladder attachment device which can improve the stability of a ladder when it is used against a wall or similar structure, or which provides a useful storage surface for equipment or materials which may used while working up a ladder. The device is very simple can be attached securely to a modern ladder with relative ease.

1. A ladder attachment device having at least a substantially rigid and substantially planar first member which is connectable at or adjacent a first end to a substantially flat portion of a rung or a top member of a ladder, and a substantially rigid and elongate second member pivotally connected at or adjacent a second end of the first member.

2. A ladder attachment device as claimed in claim 1, wherein the first member is adapted such that it can be clamped to the substantially flat portion of a rung or top member of a ladder.

3. A ladder attachment device as claimed in claim 1, wherein the first member is connectable to the substantially flat portion of a rung or top member of a ladder using at least one bolt.

4. A ladder attachment device as claimed in claim 1, wherein the first member includes at least one lug which is adapted to abut a side of the rung or top member of a ladder to which the attachment device is connected.

5. A ladder attachment device as claimed in claim 1, wherein, the first member includes at least two lugs which are adapted to abut a side of the rung or top member of a ladder, one of each of the said lugs being situated each side of a first centreline of the first member, the first centreline being that which extends from the first end of the first member to the second end.

6. A ladder attachment device as claimed in claim 1, wherein the distance between the first end and the second end of the first member is within the range of between about two hundred millimetres and six hundred millimetres.

7. A ladder attachment device as claimed in claim 1, wherein the length of the second member is greater than the width of a ladder to which the device is to be secured.

8. A ladder attachment device as claimed in claim 1, wherein the length of the second member is greater than four hundred millimetres.

9. A ladder attachment device-as claimed in claim 1, wherein the width of the first member perpendicular to the first centreline of the device is within the range of two hundred and four hundred millimetres.

10. A ladder attachment device as claimed in claim 1, wherein the second member is provided with a friction enhancing material on at least part of its surface.

11. A ladder attachment device as claimed in claim 1, wherein the second member is pivotally connectable to the first member about a pivot axis that is substantially perpendicular to the first centreline of the first member.

12-13. (canceled)

14. A ladder attachment device as claimed in claim 2, wherein the length of the second member is greater than four hundred millimetres.

15. A ladder attachment device as claimed in claim 3, wherein the length of the second member is greater than four hundred millimetres.

16. A ladder attachment device as claimed in claim 4, wherein the length of the second member is greater than four hundred millimetres.

17. A ladder attachment device as claimed in claim 5, wherein the length of the second member is greater than four hundred millimetres.

18. A ladder attachment device as claimed in claim 6, wherein the length of the second member is greater than four hundred millimetres.
